(19) United States
(12) Patent Application Publication
(10) Pub. No.: US 2026/0209644 A1
(43) Pub. Date: Jul. 23, 2026

(54) FABRIC FRAGRANCE-RETAINING AND STAIN-REMOVING COMPOSITION CONTAINING ANIONIC SURFACTANT AND PREPARATION METHOD THEREOF

(71) Applicant: Guangzhou Joyson Cleaning Products Co., Ltd., Guangzhou (CN)

(72) Inventors: Fenglei LI, Guangzhou (CN); Jieer LUO, Guangzhou (CN); Min SUN, Guangzhou (CN); Jieting YAN, Guangzhou (CN); Junli LI, Guangzhou (CN)

(21) Appl. No.: 19/075,855

(22) Filed: Mar. 11, 2025

Related U.S. Application Data
(63) Continuation of application No. PCT/CN2025/073159, filed on Jan. 18, 2025.

(51) Int. Cl. C11D 3/37; C11D 1/10; C11D 1/14; C11D 1/28; C11D 1/37; C11D 3/18; C11D 3/20; C11D 3/22; C11D 3/24; C11D 3/33; C11D 3/382; C11D 3/48; C11D 11/00; C11D 17/06

(52) U.S. Cl. CPC C11D 3/3707; C11D 1/37; C11D 3/187; C11D 3/2086; C11D 3/221; C11D 3/222; C11D 3/24; C11D 3/33; C11D 3/382; C11D 3/48; C11D 11/0082; C11D 17/06; C11D 1/10; C11D 1/143; C11D 1/146; C11D 1/28

(57) ABSTRACT

The present application relates to a fabric fragrance-retaining and stain-removing composition containing an anionic surfactant and a preparation method thereof. The composition includes: binder, anionic surfactant, filler, water softener, auxiliary agent, antioxidant, antibacterial and acaricide agent, and essence. The fragrance-retaining and stain-removing composition of the present application has the features of resisting high temperature of 55° C., resisting high humidity and instant dissolution in cold water, and has stain-removing, long-lasting fragrance retention, and good antibacterial and mite-removing effects on fabrics.

### CROSS-REFERENCE TO RELATED APPLICATION

The present continuation of PCT application serial no. PCT/CN2025/073159, filed on Jan. 18, 2025. The entirety of PCT application serial no. PCT/CN2025/073159 is hereby incorporated by reference herein and made a part of this specification.

### TECHNICAL FIELD

The present application relates to the field of fabric stain-removing products and, more particularly, to a fabric fragrance-retaining and stain-removing composition containing an anionic surfactant and a preparation method thereof.

### BACKGROUND ART

Fragrance beads have become one of the most important laundry care products since their introduction into the market in 2011. Polyethylene glycol (PEG) is a non-toxic, odorless, and tasteless substance whose combustion products are carbon dioxide and water vapor without causing pollution to the environment. Therefore, most of the common fragrance beads and fragranced fabric softeners currently use PEG as a main part, which accounts for up to 90% by weight.

However, the fragrance beads prepared with polyethylene glycol as the main part have some defects. For example, PEG requires high-temperature melting, and the essence requires high-temperature addition and mixing, and this preparation process is liable to cause loss of essence; furthermore, in the cooling granulation process, it is necessary to maintain a low-temperature environment for a long period of time, and both the mixing process and the granulation process require a large amount of energy consumption. On the other hand, when the temperature is higher than 50° C., the fragrance beads prepared with polyethylene glycol as the main part are easy to self-melt, causing the adhesion between particles to form lumps, affecting the product quality and consumer experience.

Patent CN202311310054.3 provides a high temperature resistant fragrance beads and a preparation method thereof, wherein the finished fragrance beads prepared by encapsulation using up to 90% enzymolysis starch have the advantage of being resistant to high temperatures of 50° C. However, enzymolysis starch is a small molecule starch and a direct carbon source for bacteria and fungi. After the finished fragrance beads are opened many times by consumers, enzymolysis starch gradually absorbs moisture, and microorganisms in the air may cause the fragrance beads to mildew. In addition, the fragrance beads contain 0.01-40 parts of water, and although water can wet the starch-based filler, the starch swells with water, loses crystallinity, and becomes a paste with viscosity, so that different materials are more intimately mixed, and at the same time, the gelatinization temperature of the starch is reduced; however, too much moisture can cause the material to soften during screw extrusion, reducing yield. In addition, when water is mixed with low-carbon-chain alcohols or water-soluble high-molecular compounds, it is difficult to completely remove the moisture in the extrusion granulation step due to the hydrogen bonding association. However, setting an excessive extrusion temperature to remove moisture may lead to material scorching and essence loss, and additionally adding a drying process to remove moisture may also further increase essence loss.

### SUMMARY

In view of the above shortcomings and deficiencies, an object of the present application is to provide a fabric fragrance-retaining and stain-removing composition containing an anionic surfactant and a preparation method thereof. A preservative-free product can also be prepared without adding water in a preparation process of the present application to avoid producing microorganisms in the product. The fragrance-retaining and stain-removing composition obtained by this preparation method has the features of resisting high temperature of 55° C., resisting high humidity and instant dissolution in cold water, and has stain-removing, long-lasting fragrance retention, and good antibacterial and mite-removing effects on fabrics.

In a first aspect, the present application provides a fabric fragrance-retaining and stain-removing composition containing an anionic surfactant, adopting the following technical solution:

A fabric fragrance-retaining and stain-removing composition containing an anionic surfactant, including the following raw materials by weight percentages: 5-29% binder, 10-35% anionic surfactant, 5-60% filler, 1-6% water softener, 0.5-5% auxiliary agent, 0.01-2% antioxidant, 0.05-1% antibacterial and acaricide agent, and 1-15% essence;
the binder includes binder A, binder B, and binder C; in the raw materials of the fabric fragrance-retaining and stain-removing composition, the weight percentage of the binder A is 5-20%, the weight percentage of the binder B is 0.5-10%, and the weight percentage of the binder C is 0.05-4%;
the binder A includes at least one of sucrose, glucose, fructose, and lactose;
the binder B includes at least one of polyethylene glycol, and polypropylene glycol;
the binder C includes at least one of sucrose fatty acid ester, polyethylene glycol glucoside fatty acid ester, PEG-120 methyl glucose triisostearate, and PEG-120 methyl glucose dioleate.

Preferably, the anionic surfactant includes at least one of sodium alkyl sulfate, sodium alpha-alkenyl sulfonate, sodium cocoyl methyl taurate, and sodium lauroyl glutamate.

Preferably, the binder A is sucrose, the binder B is a mixture of polyethylene glycol and polypropylene glycol, and the binder C is a mixture of sucrose fatty acid ester, polyethylene glycol glucoside fatty acid ester, and PEG-120 methyl glucose dioleate;

in the raw materials of the fabric fragrance-retaining and stain-removing composition, the weight percentage of sucrose is 12-18%, the weight percentage of polyethylene glycol is 1-9%, the weight percentage of polypropylene glycol is 1-8%, the weight percentage of sucrose fatty acid ester is 0.1-3%, the weight percentage of polyethylene glycol glucoside fatty acid ester is 0.5-1.5%, and the weight percentage of PEG-120 methyl glucose dioleate is 0.1-3%.

Preferably, in the raw materials of the fabric fragrance-retaining and stain-removing composition, the weight percentage of sucrose is 12-18%, the weight percentage of polyethylene glycol is 3-6%, the weight percentage of polypropylene glycol is 0.5-2%, the weight percentage of sucrose fatty acid ester is 0.5-1.5%, the weight percentage of polyethylene glycol glucoside fatty acid ester is 0.5-1.5%, and the weight percentage of PEG-120 methyl glucose dioleate is 0.5-1.5%.

By using the above-mentioned technical solution, the binder is selected from sucrose, glucose, fructose, and lactose, and these substances have moderate adhesive force, which can not only ensure the tight bonding between materials but also do not cause excessive adhesion and affect the appearance of the product.

Meanwhile, polyethylene glycol, polypropylene glycol, sucrose fatty acid ester, polyethylene glycol glucoside fatty acid ester, PEG-120 methyl glucose triisostearate, and PEG-120 methyl glucose dioleate contain a large number of hydroxyl groups in the molecule. On the one hand, these hydroxyl groups can form hydrogen bonds with water molecules, thereby “locking” water in their molecular structure. When the humidity in the environment is high, these substances can quickly absorb and retain moisture; on the other hand, they further have excellent film-forming properties, and when mixed with other powders, at a certain temperature, they can rapidly form a film on the surface of other powder particles, which can insulate external moisture, and can also bind different material powders closely together.

Preferred anionic surfactants, such as sodium alkyl sulfate, sodium alpha-alkenyl sulfonate, sodium cocoyl methyl taurate, sodium lauroyl glutamate, not only have good stain-removing properties but also act as wetting agents. When the fabric fragrance-retaining and stain-removing composition is placed in a large amount of water, water molecules can be made to penetrate better into the interior of the fabric fragrance-retaining and stain-removing composition, thereby increasing the dispersion solubility of the fabric fragrance-retaining and stain-removing composition.

Preferably, a particle size of the binder A, the binder B, and the binder C is between 50 and 200 mesh.

Preferably, the filler includes at least two of maltodextrin, cyclodextrin, plant starch, porous starch, and cellulose.

Preferably, the filler is a mixture of maltodextrin, cyclodextrin, plant starch, porous starch, and cellulose. In the raw materials of the fabric fragrance-retaining and stain-removing composition, the weight percentage of maltodextrin is 5-10%, the weight percentage of cyclodextrin is 3-7%, the weight percentage of plant starch is 5-15%, the weight percentage of porous starch is 3-7%, and the weight percentage of cellulose is 1-5%.

Preferably, the plant starch includes one or more of tapioca starch, corn starch, potato starch, pea starch, corn starch, and tapioca starch.

Preferably, the cellulose is microcrystalline cellulose.

By using the above-mentioned technical solution, the filler is further preferred; under the action of shearing, friction, and heating of a screw extruder, filler materials such as dextrin and starch are gelatinized and expanded, so that the dextrin and starch undergo a phase change, so as to enhance the toughness and expandability of a closed structure, so that more pore structures are formed in the interior of the fragrance-retaining and stain-removing composition, and when placed in water, water enters the interior of the fragrance-retaining and stain-removing composition through the pore structures, so as to promote the dispersion and dissolution thereof in water; at the same time, it is further beneficial to disperse a colorant, ensuring a uniform and more aesthetically pleasing product appearance.

Furthermore, in the fragrance-retaining and stain-removing composition, the co-coordination of the binder A, the filler, and the anionic surfactant can effectively hinder a heat transfer, slowing down the heat transfer rate of binder B and C in high-temperature environments, and thereby enhancing the high-temperature resistance of the fragrance-retaining and stain-removing composition.

Preferably, the antibacterial and acaricide agent includes at least one of dichlorobenzyl alcohol, cymene, zanthoxylum extract, and rice hull extract.

Preferably, the antibacterial and acaricide agent is a mixture of zanthoxylum extract and rice hull extract. In the raw materials of the fabric fragrance-retaining and stain-removing composition, the weight percentage of zanthoxylum extract is 0.2-2%, and the weight percentage of rice hull extract is 0.05-0.65%.

Preferably, the auxiliary agent includes at least one of glycerol, propylene glycol, butylene glycol, hexylene glycol, sorbitol, and isooctanol.

Preferably, the water softener includes at least one of sodium citrate, tetrasodium iminodisuccinate, tetrasodium glutamate diacetate, and trisodium methylglycine diacetate.

Preferably, the antioxidant includes one or more of dibutyl hydroxytoluene, ascorbyl palmitate, and tert-butyl hydroquinone.

Preferably, the sodium alkyl sulfate includes one or more of sodium dodecyl sulfate, sodium tetradecyl sulfate, sodium hexadecyl sulfate, sodium octadecyl sulfate, and sodium eicosanyl sulfate.

Preferably, the essence includes a liquid essence and a microcapsule essence.

Preferably, in the raw materials of the fabric fragrance-retaining and stain-removing composition, the weight percentage of the liquid essence is 1 to 15% and the weight percentage of the microcapsule essence is 1 to 10%.

Preferably, a length and a width of the fabric fragrance-retaining and stain-removing composition are 3 mm to 10 mm, a thickness of the fabric fragrance-retaining and stain-removing composition is 0.6 mm to 3 mm, and a density of the fabric fragrance-retaining and stain-removing composition is 0.6 to 1.2 g/mL.

A suitable amount of the colorant can be added to the fabric fragrance-retaining and stain-removing composition according to actual needs.

In a second aspect, the present application provides a method for preparing the fabric fragrance-retaining and stain-removing composition containing an anionic surfactant, adopting the following technical solution:

A method for preparing the fabric fragrance-retaining and stain-removing composition containing an anionic surfactant, including the following steps: mixing and stirring the raw materials to form dry granulars, and then heating at 65° C.-75° C. to melt, and extruding and pelletizing to obtain the fabric fragrance-retaining and stain-removing composition containing an anionic surfactant.

By using the above-mentioned technical solution, in the present application, no additional water is added and extrusion is performed at a temperature of 65° C.-75° C. to achieve tight bonding between materials, avoiding the need for drying water at a high temperature or the additional manufacturing process of drying water. Through the cooperation of the binder A, the binder B, the binder C, the filler, and the anionic surfactant, the obtained fragrance-retaining and stain-removing composition has excellent properties of resisting high temperature of 55° C., resisting high humidity and instant dissolution in cold water.

In addition, the fragrance-retaining and stain-removing composition provided in the present application can achieve a highly effective mite-removing effect by adding only a small amount of the antibacterial and acaricide agent.

In summary, the present application has the following beneficial effects:
1. High-temperature resistance: the co-coordination of the binder A, the filler, and the anionic surfactant imparts the composition resistance to high temperatures of 55° C., allowing the composition to maintain excellent performance in a variety of high-temperature application scenarios.
2. Humidity resistance: in the present application, polyethylene glycol, polypropylene glycol, and other substances are preferably utilized, which contain a large number of hydroxyl groups. These hydroxyl groups can form hydrogen bonds with water molecules, effectively “locking” water and thereby endowing the fragrance-retaining and detergent composition with excellent moisture resistance.
3. Water free: the preparation method of the present application does not require additional water, avoids the problem of microbial contamination caused by the introduction of water, and at the same time omits the manufacturing process of drying water at a high temperature.
4. Rapid dissolution: the filler such as dextrin and starch are gelatinized and expanded under the action of shearing, friction, and heating of the screw extruder, forming more pore structures. In combination with the preferred anionic surfactant, water molecules can rapidly penetrate through these pore structures, wet the interior, promote dispersion and dissolution in water, and impart the characteristic of rapid dissolution in cold water to the fragrance-retaining and stain-removing composition.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the appearance of the compositions prepared in Examples 2, 3, 5, and Comparative Example 6.

FIG. 2 shows the state of the compositions of Examples 1, 2, 3, and 4 after being stored at 60° C. for 20 months.

FIG. 3 shows the state of the compositions of Example 1, Comparative Example 1, Comparative Example 6, and Comparative Example 8 after being placed at 25° C. and 60° C. for 1 month.

Taking Example 1 as an example, the left side shows the state after being placed at 25° C. for 1 month, and the right side shows the state after being placed at 60° C. for 1 month. The same applies to the remaining groups: 25° C. (left), 60° C. (right).

FIG. 4 shows the state of the compositions of Comparative Examples 1-3 and Comparative Example 5 after being stored at 25° C. for 1 month.

FIG. 5 shows the state of the composition of Comparative Example 4 after being stored at 55° C. for 1 month.

FIG. 6 shows the state of the composition of Comparative Example 1 after being stored at 25° C. for 6 months.

### DETAILED DESCRIPTION

The present application will be further described in detail with reference to the drawings and examples.

The raw materials used in the following examples and comparative examples are all commercially available.

The following are some sources of raw materials:

Polyethylene glycol was purchased from Dow Chemical Company, USA, having a molecular weight of 6000-12000.

Polypropylene glycol was purchased from Dow Chemical Company, USA, having a molecular weight of 3000-8000.

Porous starch was purchased from Shaanxi Bovlin Biotechnology Co. Ltd.

Microcrystalline cellulose was purchased from Wensheng Biotechnology (Guangzhou) Co. Ltd.

Acrylic acid homopolymer was purchased from BASF (China) Co. Ltd., model Polyquart 149.

Modified starch was purchased from BASF (China) Co. Ltd., model Poiyquart S Granules.

Pregelatinized starch was purchased from Nantong Gaofeng Biotechnology Co. Ltd., model GF-K200.

### EXAMPLES

### Example 1

A fabric fragrance-retaining and stain-removing composition containing an anionic surfactant includes the following raw materials: binder, anionic surfactant, filler, water softener, auxiliary agent, antioxidant, antibacterial and acaricide agent, and essence; the binder includes binder A, binder B, and binder C.

The specific selection and specific weight percentage content of raw materials for each preparation are shown in Table 1.

After testing, the fabric fragrance-retaining and stain-removing composition containing an anionic surfactant prepared in the present application has a length and width of preferably 3 mm to 10 mm, a thickness of preferably 0.6 mm to 3 mm, a density of preferably 0.6-1.2 g/mL as measured by drainage method, and has a shape of a polygon, heart, polygon, multi-petal flower, and any other form of water-soluble composition. Corresponding dimensions and specifications can be prepared according to the actual situation.

The example further provides a method for preparing the fabric fragrance-retaining and stain-removing composition containing an anionic surfactant, included the following steps:
Step 1: the binder A, binder B, and binder C were added into a container, and then the auxiliary agent, filler, water softener, and anionic surfactant were added; after sufficient stirring, a first resulting mixture was transferred into a stirring chamber connected to an extrusion granulator;
Step 2: then the essence, antibacterial and acaricide agent, and antioxidant were added into the stirring chamber, and a second resulting mixture was stirred continually to form dry granulars;
Step 3: then the second resulting mixture was heated and melted through a screw extruder, extruded, and cut into granules using a rotating cutter.

The screw extruder extruded at a temperature of 70° C.

### Example 2

A fabric fragrance-retaining and stain-removing composition containing an anionic surfactant, differing from Example 1 in that the particle size of binder A, binder B, and binder C was 50 mesh.

The specific selection and specific weight percentage content of raw materials for each preparation are shown in Table 1.

A method for preparing the fabric fragrance-retaining and stain-removing composition containing an anionic surfactant, differing from Example 1 in that the screw extruder extruded at a temperature of 75° C.

### Example 3

A fabric fragrance-retaining and stain-removing composition containing an anionic surfactant, differing from Example 1 in that the particle size of binder A, binder B, and binder C was 200 mesh.

The specific selection and specific weight percentage content of raw materials for each preparation are shown in Table 1.

A method for preparing the fabric fragrance-retaining and stain-removing composition containing an anionic surfactant, differing from Example 1 in that the screw extruder extruded at a temperature of 65° C.

### Examples 4-9

A fabric fragrance-retaining and stain-removing composition containing an anionic surfactant, differing from Example 1 in that the specific selection and specific weight percentage content of raw material for each preparation were detailed in Table 1.

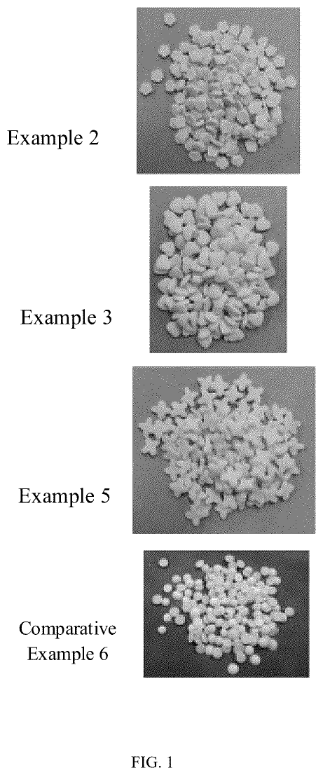

The appearance view of the compositions prepared in Examples 2, 3, and 5 was shown in FIG. 1.

The pink color of the composition of Example 2 was due to the addition of a suitable amount of a colorant during preparation, and the same was true for the color of the composition in the remaining pictures.

Specifically, with respect to plant starch, the plant starch was tapioca starch in Example 1, the plant starch was corn starch in Example 2, the plant starch was potato starch in Example 6, the plant starch was pea starch in Example 7, the plant starch was corn starch in Example 8, and the plant starch was tapioca starch in Example 9.

With regard to the sodium alkyl sulfate, the sodium alkyl sulfate was sodium dodecyl sulfate in Example 1, the sodium alkyl sulfate was sodium tetradecyl sulfate in Example 3, the sodium alkyl sulfate was sodium hexadecyl sulfate in Example 5, the sodium alkyl sulfate was sodium octadecyl sulfate in Example 8, and the sodium alkyl sulfate was sodium eicosanyl sulfate in Example 9.

TABLE 1

| | | Weight percentage (%) | | | | | | | | |
|---|---|---|---|---|---|---|---|---|---|---|
| | | Example | Example | Example | Example | Example | Example | Example | Example | Example |
| Component | | 1 | 2 | 3 | 4 | 5 | 6 | 7 | 8 | 9 |
| Binder A | Sucrose | 15 | 8 | / | 1 | / | 14 | 16 | 5.8 | 2 |
| | Glucose | / | / | 18 | 10 | / | 2 | / | / | / |
| | Fructose | / | 1 | / | 1 | / | / | / | / | 3 |
| | Lactose | 1 | / | / | 2 | 18.4 | 1 | / | / | 2 |
| Binder B | Polyethylene | 5 | / | 8.5 | 1 | 9 | 3 | / | 1.1 | 4 |
| | glycol | | | | | | | | | |
| | Polypropylene | 1 | 8 | / | / | / | 4 | 1 | / | 4 |
| | glycol | | | | | | | | | |
| Binder C | Polyethylene | 1 | 3 | / | 0.1 | 3 | 2 | 1 | 0.1 | / |
| | glycol | | | | | | | | | |
| | glucoside | | | | | | | | | |
| | fatty acid | | | | | | | | | |
| | ester | | | | | | | | | |
| | Sucrose | 1 | / | / | 0.5 | / | 0.5 | / | / | / |
| | fatty acid | | | | | | | | | |
| | ester | | | | | | | | | |
| | PEG-120 | / | / | 1.5 | / | / | 0.2 | / | / | 0.5 |
| | methyl | | | | | | | | | |
| | glucose | | | | | | | | | |
| | triisostearate | | | | | | | | | |
| | PEG-120 | 1 | / | / | / | / | 0.1 | / | 3 | / |
| | methyl | | | | | | | | | |
| | glucose | | | | | | | | | |
| | dioleate | | | | | | | | | |
| Filler | Maltodextrin | 8 | / | 24 | / | 4 | / | / | / | 30 |
| | Cyclodextrin | 5 | / | / | 17 | 3 | / | / | / | 5 |
| | Plant starch | 10 | 16 | / | / | 23 | 38.5 | / | 2 | 15 |
| | Porous | 5 | 30 | / | 9 | 2 | / | / | 52 | / |
| | starch | | | | | | | | | |
| | Microcrystalline | 2 | / | / | 20 | 1 | 14.4 | 55 | / | / |
| | cellulose | | | | | | | | | |
| Anionic | Sodium | 30 | / | 30 | / | 4 | / | / | 10 | 3 |
| surfactant | alkyl | | | | | | | | | |
| | sulfate | | | | | | | | | |
| | Sodium | / | 15 | / | / | 7 | 10 | 10 | / | / |
| | alpha-alkenyl | | | | | | | | | |
| | sulfonate | | | | | | | | | |
| | Sodium | / | 5 | 2 | 17 | 3 | / | / | 2 | 10 |
| | cocoyl | | | | | | | | | |
| | methyl | | | | | | | | | |
| | taurate | | | | | | | | | |
| | Sodium | / | 5 | 10 | 3 | 2.2 | 1 | 1 | / | / |
| | lauroyl | | | | | | | | | |
| | glutamate | | | | | | | | | |
| Water | Sodium | 2 | / | / | 1 | / | 2 | / | / | 1 |
| softener | citrate | | | | | | | | | |
| | Tetrasodium | / | 1.35 | / | 1 | / | 1 | 1 | / | 1 |
| | iminodisuccinate | | | | | | | | | |
| | Tetrasodium | / | / | 1.5 | 1 | / | / | 1 | 1 | / |
| | glutamate | | | | | | | | | |
| | diacetate | | | | | | | | | |
| | Trisodium | / | / | / | 1 | 2.3 | / | / | 2 | 1 |
| | methylglycine | | | | | | | | | |
| | diacetate | | | | | | | | | |
| Antioxidant | L-ascorbyl | 0.15 | / | / | 0.2 | / | 0.34 | 0.1 | 1.5 | 0.02 |
| | palmitate | | | | | | | | | |
| | Dibutyl | / | 0.15 | / | 0.05 | 0.2 | / | 0.1 | 0.5 | 0.02 |
| | hydroxytoluene | | | | | | | | | |
| | Tert-butyl | / | / | 0.15 | / | / | 0.05 | 0.1 | 0.35 | 0.02 |
| | hydroquinone | | | | | | | | | |
| Auxiliary | Glycerol | 3.9 | / | / | / | / | 2 | / | 1.1 | 1 |
| agent | Propylene | / | 2 | / | / | / | / | / | 1 | 2 |
| | glycol | | | | | | | | | |
| | Butylene | / | / | 2 | / | / | / | 3 | 1 | 1 |
| | glycol | | | | | | | | | |
| | Hexylene | / | / | / | 2.2 | / | / | / | / | / |
| | glycol | | | | | | | | | |
| | Sorbitol | / | / | / | / | 4 | / | 1 | / | / |
| | Isooctanol | 1 | / | / | / | / | 1 | / | / | 1 |
| Essence | Liquid | 5 | 1 | 1 | 10 | 8 | 1.2 | 5.1 | 13 | 5 |
| | essence | | | | | | | | | |
| | Microcapsule | 3 | 4 | 1 | 1 | 5.1 | 1.1 | 2 | 1.65 | 9 |
| | essence | | | | | | | | | |
| antibacterial | Dichlorobenzyl | 1 | / | 0.25 | 0.2 | 0.8 | / | 0.6 | 0.9 | / |
| and | alcohol | | | | | | | | | |
| acaricide | Cymene | / | 0.5 | / | 0.7 | / | / | / | / | / |
| agent | Rice hull | 0.45 | / | / | / | / | / | 2 | / | 0.24 |
| | extract | | | | | | | | | |
| | Zanthoxylum | 0.5 | / | 0.1 | 0.05 | / | 0.61 | / | / | 0.2 |
| | extract | | | | | | | | | |

### COMPARATIVE EXAMPLES

### Comparative Example 1

A composition including the following components by weight percentages: 84.45% sucrose pellets, 3% microcapsule essence, 5% liquid essence, 2% propylene glycol, 4.2% white carbon black, 0.2% ethylenediaminetetraacetic acid tetrasodium salt, 0.45% zanthoxylum extract, 0.5% rice hull extract, and 0.2% dye.

Preparation method: the sucrose pellets were added into a stirring pot at room temperature, and then the microcapsule essence, the liquid essence, and the dye were added and stirred until uniform; then propylene glycol, ethylenediamine tetra-acetic acid tetrasodium salt, zanthoxylum extract and rice hull extract were added correspondingly in the stirring pan; then, white carbon black was slowly added into the stirring pan, and stirred continually until the adsorbent (white carbon black) and the microcapsule essence were uniformly coated on the surface of the water-soluble particles to obtain the composition.

### Comparative Example 2

A composition, differing from Comparative Example 1 in that sucrose crystals are used to replace the sucrose pellets in an equal amount.

### Comparative Example 3

A composition including the following components by weight percentages: 67.75% sodium chloride crystals, 4.9% sucrose crystals, 5% sodium citrate crystals, 3% microcapsule essence, 5% liquid essence, 2% propylene glycol, 4.2% white carbon black, 5% bentonite, 2% 4A zeolite, 0.45% zanthoxylum extract, 0.5% rice hull extract, and 0.2% dye.

Preparation method: the sucrose crystals, sodium chloride crystals, and sodium citrate crystals were added into a stirring pot at room temperature, then the microcapsule essence, liquid essence, and dye were added and stirred until uniform; then propylene glycol, zanthoxylum extract, and rice hull extract were added correspondingly in the stirring pot; then, the white carbon black, bentonite, and 4A zeolite were slowly added into the stirring pan, and stirred continually until the white carbon black, bentonite and 4A zeolite and the microcapsule essence were uniformly coated on the surface of the water-soluble particles to obtain the composition.

### Comparative Example 4

A composition including the following components by weight percentages: 75.2% polyethylene glycol, 10% solid fatty alcohol polyoxyethylene ether (EO50), 5.8% acrylic acid homopolymer, 3% microcapsule essence, 5% liquid essence, 0.45% zanthoxylum extract, 0.5% rice hull extract, and 0.2% dye.

Preparation method: the polyethylene glycol and fatty alcohol polyoxyethylene ether (EO50) were added into a stirring container, heated to 75-80° C., and stirred to a uniform liquid state; the remaining raw materials, except the liquid essence, microcapsule essence, and dye were added into the stirring container under a heat preservation condition, stirred and dispersed uniformly; the liquid essence, microcapsule essence and dye were continually added into the stirring container, and stirred until uniform; a resulting mixture in the stirred container was passed into a granulation device (90° C.) for granulation, and granules prepared were solidified, cooled and packaged to obtain the composition.

### Comparative Example 5

A composition including the following components in parts by weight: 90 parts of modified starch, 10 parts of glycerol, 18 parts of polyethylene glycol stearate, 3 parts of microcapsule essence, 5 parts of liquid essence, 0.45 parts of zanthoxylum extract, 0.5 parts of rice hull extract, 0.2 parts of dye, and 40.5 parts of water.

Preparation method: the modified starch and polyethylene glycol stearate were mixed with stirring; the rice hull extract, zanthoxylum extract, microcapsule essence, liquid essence, dye, water and glycerol were added, heated to 60° C., stirred and mixed well to obtain a mixture material; the mixed material was fed into a screw extrusion granulator, extruded through a screw extruder (90° C.) and cut by a rotary cutter, cooled and shaped to obtain the composition.

### Comparative Example 6

A composition including the following components by weight percentages: 70.85% polyethylene glycol, 10% sodium fatty alcohol polyoxyethylene ether sulfate, 5% starch, 5% sodium citrate, 3% microcapsule essence, 5% liquid essence, 0.45% zanthoxylum extract, 0.5% rice hull extract, and 0.2% dye.

Preparation method: the polyethylene glycol and sodium fatty alcohol polyoxyethylene ether sulfate were added into a stirring container, heated to 75-80° C., and stirred to a uniform liquid state; the remaining raw materials, except the liquid essence, microcapsule essence, and dye were added into the stirring container under a heat preservation condition, stirred and dispersed uniformly; the liquid essence, microcapsule essence, and dye were continually added into the stirring container, and stirred until uniform; a resulting mixture in the stirred container was passed to a granulation device (90° C.) for granulation, and granules prepared were solidified, cooled and packaged to obtain the composition (see FIG. 1).

### Comparative Example 7

A composition including the following components by weight percentages: 23.8% sucrose powder, 3% microcapsule essence, 5% liquid essence, 12.05% polyethylene glycol, 5% citric acid, 20% polyoxyethylene fatty alcohol ether, 30% water, 0.45% zanthoxylum extract, 0.5% rice hull extract, and 0.2% dye.

Preparation method: a mixture of the polyethylene glycol and water were heated and dissolved at 85° C., added into a stirring container, and then the fatty alcohol polyoxyethylene ether, citric acid, sucrose powder, microcapsule essence, liquid essence, zanthoxylum extract, rice hull extract and dye were added successively; stirred until uniform, a resulting mixture in the stirring container was passed into a granulation device (90° C.) for granulation; granules prepared were solidified, cooled and packaged to obtain the composition.

### Comparative Example 8

A composition, differing from Example 2 in that the plant starch and the porous starch were replaced by the pregelatinized starch in equal amounts, i.e. the amount of pregelatinized starch was the sum of the plant starch and the porous starch.

### Comparative Example 9

A composition, differing from Example 1 in that no filler was added and sucrose was supplemented in an equal amount.

### Comparative Example 10

A composition, differing from Example 1 in that no binder A was added and sucrose was supplemented in an equal amount.

### Comparative Example 11

A composition, differing from Example 1 in that no binder B was added and sucrose was supplemented in an equal amount.

### Comparative Example 12

A composition, differing from Example 1 in that no binder C was added and sucrose was supplemented in an equal amount.

### Comparative Example 13

A composition, differing from Example 1 in that no anionic surfactant was added and sucrose was supplemented in an equal amount.

### Comparative Example 14

A composition, differing from Example 1 in that an additional 20% deionized water was added.

### Performance Test Experiment

### 1. Detergency Test:

The detergency is determined according to GB/T 13174-2021 “Determination of detergency and cycle of washing property for laundry detergents”, the washing water is 250 mg/kg CaCl₂) hard water, the test cloth is national standard carbon black JB-01 dirty cloth, national standard protein JB-02 dirty cloth and national standard sebum JB-03 dirty cloth.

Using 0.2% standard laundry detergent as a control, the stain-removing ratio Pi was obtained, wherein when Pi≥1.0 was qualified, Pi<1.0 was unqualified. The results were reported in Table 2.

TABLE 2

| | | National | | | |
|---|---|---|---|---|---|
| | | standard | National | National | |
| | | carbon | standard | standard | |
| | | black | protein | sebum | |
| | Concen- | dirty | dirty | dirty | |
| Groups | tration | cloth | cloth | cloth | determination |
| Example 1 | 0.2% | 1.64 | 1.82 | 1.25 | Qualified |
| Example 2 | 0.2% | 1.32 | 1.64 | 1.34 | Qualified |
| Example 3 | 0.2% | 1.53 | 1.71 | 1.17 | Qualified |
| Example 4 | 0.2% | 1.34 | 1.33 | 1.14 | Qualified |
| Example 5 | 0.2% | 1.14 | 1.27 | 1.20 | Qualified |
| Example 6 | 0.2% | 1.23 | 1.38 | 1.21 | Qualified |
| Example 7 | 0.2% | 1.16 | 1.18 | 1.21 | Qualified |
| Example 8 | 0.2% | 1.03 | 1.16 | 1.12 | Qualified |
| Example 9 | 0.2% | 1.02 | 1.00 | 1.14 | Qualified |
| Comparative | 0.2% | 0.41 | 0.44 | 0.56 | Unqualified |
| Example 1 | | | | | |
| Comparative | 0.2% | 0.39 | 0.31 | 0.49 | Unqualified |
| Example 2 | | | | | |
| Comparative | 0.2% | 0.39 | 0.36 | 0.45 | Unqualified |
| Example 3 | | | | | |
| Comparative | 0.2% | 1.00 | 1.00 | 1.01 | Qualified |
| Example 4 | | | | | |
| Comparative | 0.2% | 0.74 | 0.52 | 0.61 | Unqualified |
| Example 5 | | | | | |
| Comparative | 0.2% | 0.99 | 0.91 | 0.96 | Unqualified |
| Example 6 | | | | | |
| Comparative | 0.2% | 0.98 | 0.99 | 1.00 | Unqualified |
| Example 7 | | | | | |

### 2. Dissolution Test:

At 10° C., 15° C. and 25° C., 0.50 g of the composition was quickly added into a 300 mL beaker containing 250 mL ultrapure water with a rotation speed of 800 r/min, a rotor size of φ8 mm×25 mm, and timing was started; the timing was stopped when the dispersion state of the composition in the system was no longer changed; the time was the dispersion time of the composition.

The results were reported in Table 3.

TABLE 3

| Groups | 10° C. | 15° C. | 25° C. |
|---|---|---|---|
| Example 1 | 4 min | 2 min | 59 s |
| Example 2 | 5 min | 4 min | 98 s |
| Example 3 | 4 min 25 s | 3 min | 84 s |
| Example 4 | 4 min 32 s | 2 min 31 s | 76 s |
| Example 5 | 6 min 10 s | 4 min 57 s | 100 s |
| Example 6 | 6 min | 5 min | 105 s |
| Example 7 | 6 min 13 s | 5 min 44 s | 2 min |
| Example 8 | 7 min 02 s | 6 min 25s | 3 min |
| Example 9 | 7 min 51 s | 6 min 41 s | 4 min 33 s |
| Comparative Example 1 | 12 min 25 s | 14 min 25 s | 7 min |
| Comparative Example 2 | 12 min | 11 min | 6 min |
| Comparative Example 3 | 11 min | 9 min 07 s | 5 min |
| Comparative Example 4 | 50 min | 41 min | 20 min |
| Comparative Example 5 | 22 min | 14 min | 8 min |
| Comparative Example 6 | 40 min | 32 min | 14 min |
| Comparative Example 7 | 46 min | 35 min | 15 min |
| Comparative Example 8 | >60 min | 56 min | 30 min |

The compositions of Comparative Examples 4, 6, and 7 had a dispersion time of 14-20 minutes at 25° C. due to the poor water solubility of PEG, which is more difficult to dissolve at low temperatures. In winter the water temperature was low and incomplete dissolution would remain on the fabric with poor effects.

Although the water dispersibility and adhesiveness of the pregelatinized starch were strong, the pregelatinized starch was easily overcooked and gelatinized at high temperatures, so the dissolution and dispersion time of Comparative Example 8 was increased, and it was difficult to completely dissolve at low temperatures, and the effect was also poor.

However, Examples 1-9 all dissolved in 8 minutes at the lower temperature of 10° C., full dissolution in the wash stage was achieved in the current 15-minute fast wash mode with good wash effects.

### 3. High-Temperature Resistance Test:

The composition was kept at 45° C.±2° C., 55° C.±2° C. and 60° C.±2° C. for one month, and upon returning to room temperature, observations were made for any occurrences of deformation, cracking, adhesion, discoloration, and other related phenomena.

The results were reported in Table 4.

TABLE 4

| | 45° C. | | 55° C. | | 60° C. | |
|---|---|---|---|---|---|---|
| Groups | Fragrance | Morphology | Fragrance | Morphology | Fragrance | Morphology |
| Example 1 | Unchanged | No adhesion | Unchanged | No adhesion | Unchanged | No adhesion |
| Example 2 | Unchanged | No adhesion | Unchanged | No adhesion | Unchanged | No adhesion |
| Example 3 | Unchanged | No adhesion | Unchanged | No adhesion | Unchanged | No adhesion |
| Example 4 | Unchanged | No adhesion | Unchanged | No adhesion | Unchanged | No adhesion |
| Example 5 | Unchanged | No adhesion | Unchanged | No adhesion | Unchanged | No adhesion |
| Example 6 | Unchanged | No adhesion | Unchanged | No adhesion | Unchanged | No adhesion |
| Example 7 | Unchanged | No adhesion | Unchanged | No adhesion | Unchanged | No adhesion |
| Example 8 | Unchanged | No adhesion | Unchanged | No adhesion | Unchanged | No adhesion |
| Example 9 | Unchanged | No adhesion | Unchanged | No adhesion | Unchanged | No adhesion |
| Comparative | Flavor | Adhesion and | Flavor | Melting | Fragrance | Melting |
| Example 1 | changing | hardening | changing | | loss | |
| Comparative | Flavor | Adhesion and | Flavor | Melting | Fragrance | Melting |
| Example 2 | changing | hardening | changing | | loss | |
| Comparative | Flavor | Adhesion and | Flavor | Melting | Fragrance | Melting |
| Example 3 | changing | hardening | changing | | loss | |
| Comparative | Fragrance | No adhesion | Fragrance | Discoloration | Fragrance | Discoloration |
| Example 4 | lightening | | lightening | and melting | loss | and melting |
| Comparative | Fragrance | No adhesion | Fragrance | Texture | Fragrance | Texture |
| Example 5 | lightening | | lightening | softening | loss | softening |
| Comparative | Fragrance | No adhesion | Fragrance | Discoloration | Fragrance | Discoloration |
| Example 6 | lightening | | lightening | and melting | lightening | and melting |
| Comparative | Flavor | Adhesion and | Flavor | Melting | Fragrance | Melting |
| Example 7 | changing | hardening | changing | | loss | |
| Comparative | Flavor | No adhesion | Flavor | Texture | Flavor | Texture |
| Example 8 | changing | | changing | softening | changing | softening |
| Comparative | Poorly formed, not tested | | | | | |
| Example 9 | | | | | | |
| Comparative | Fragrance | Adhesion and | Fragrance | Melting | Fragrance | Melting |
| Example 10 | lightening | hardening | lightening | | lightening | |
| Comparative | Fragrance | Adhesion and | Fragrance | Melting | Fragrance | Melting |
| Example 11 | lightening | hardening | lightening | | lightening | |
| Comparative | Fragrance | Adhesion and | Fragrance | Melting | Fragrance | Melting |
| Example 12 | lightening | hardening | lightening | | lightening | |
| Comparative | Fragrance | Adhesion and | Fragrance | Melting | Fragrance | Melting |
| Example 13 | lightening | hardening | lightening | | lightening | |

| | |
|---|---|
| Comparative | Poorly formed, not tested |
| Example 14 | |

### 4. Humidity Resistance Test:

The composition was kept at 60% RH and 70% RH for one month at 40° C.±2° C., and upon returning to room temperature, observations were made for any occurrences of adhesion or discoloration.

The results were reported in Table 5.

TABLE 5

| | 60% RH | | 70% RH | |
|---|---|---|---|---|
| Groups | Morphology | Fragrance | Morphology | Fragrance |
| Example 1 | No adhesion | Unchanged | No adhesion | Unchanged |
| Example 2 | No adhesion | Unchanged | No adhesion | Unchanged |
| Example 3 | No adhesion | Unchanged | No adhesion | Unchanged |
| Example 4 | No adhesion | Unchanged | No adhesion | Unchanged |
| Example 5 | No adhesion | Unchanged | No adhesion | Unchanged |
| Example 6 | No adhesion | Unchanged | No adhesion | Unchanged |
| Example 7 | No adhesion | Unchanged | No adhesion | Unchanged |
| Example 8 | No adhesion | Unchanged | No adhesion | Unchanged |
| Example 9 | No adhesion | Unchanged | No adhesion | Unchanged |
| Comparative | Adhesion and | Flavor | Adhesion and | Flavor |
| Example 1 | hardening | changing | hardening | changing |
| Comparative | Adhesion and | Flavor | Adhesion and | Flavor |
| Example 2 | hardening | changing | hardening | |
| Comparative | Adhesion and | Flavor | Adhesion and | Flavor |
| Example 3 | hardening | changing | hardening | changing |
| Comparative | Adhesion and | Fragrance | Adhesion and | Flavor |
| Example 4 | hardening | lightening | hardening | changing |
| Comparative | Adhesion and | Fragrance | Adhesion, hardening, | Flavor |
| Example 5 | hardening | lightening | and softening | changing |
| Comparative | Adhesion and | Fragrance | Adhesion and | Flavor |
| Example 6 | hardening | lightening | hardening | changing |
| Comparative | Adhesion and | Flavor | Adhesion and | Flavor |
| Example 7 | hardening | changing | hardening | changing |
| Comparative | Adhesion and | Flavor | Adhesion, hardening, | Flavor |
| Example 8 | hardening | changing | and softening | changing |
| Comparative | Adhesion and | Fragrance | Adhesion, hardening, | Fragrance |
| Example 10 | hardening | lightening | and softening | lightening |
| Comparative | Adhesion and | Fragrance | Adhesion, hardening, | Fragrance |
| Example 11 | hardening | lightening | and softening | lightening |
| Comparative | Adhesion and | Fragrance | Adhesion, hardening, | Fragrance |
| Example 12 | hardening | lightening | and softening | lightening |
| Comparative | Adhesion and | Fragrance | Adhesion and | Fragrance |
| Example 13 | hardening | lightening | hardening | lightening |

### 5. Evaluation Test of Fragrance Retention Effect:

2.0 g of the composition was dispersed with 1 L of CaCl₂) hard water with a gauge of 250 mg/kg to obtain a sample solution to be tested when no change in appearance occurred.

A vertical decontamination tester was open, and the above sample solution to be tested was transferred into a decontamination tank and preheated at 30° C.±1° C. 8 pieces of JB-00 test pieces were placed into the decontamination tank and stirred at 120 r/min for 20 min, while conducting a blank test.

At the end of washing, the test pieces were transferred to a rinsing machine, and drain the water; 1500 mL tap water was added to rinse for 30 s, the rinse water was drained off and the test pieces were manually spun dry for 15 s; the above steps were repeated for a total of two rinses.

The test pieces were taken out and dried in a cool, dry place in an enamel dish at room temperature. After drying, the fragrance retention effect was evaluated.

In the evaluation, the evaluator shall first rub the JB-00 test piece, and keep the JB-00 test piece at a distance of 1 cm-2 cm from the nose. Do not allow the JB-00 test piece to contact the nose and inhale slowly.

The evaluator shall fill in the evaluation results according to Table 6 and draw “∘” in the selected space.

The results were summarized in Table 7.

### 6. Evaluation of Long-Lasting Fragrance Retention Effect:

After the end of the fragrance retention effect evaluation, the test pieces were hung in the evaluation room one by one, and the fragrance retention effect was evaluated again on the 7^{th}, 30^{th}, 60^{th}, and 100^{th} day.

The results were summarized in Table 7.

TABLE 6

| | 1# | 2# | 3# | 4# | 5# |
|---|---|---|---|---|---|
| Able to smell the fragrance | | | | | |
| Unable to smell the fragrance | | | | | |

Note: the number of evaluators was 50, and the table should be increased or decreased according to the actual number of evaluators.

The result determination and calculation formula were as follows:

$$Y = \frac{A}{B} \times 100 \%$$

Wherein, Y: Percentage of evaluators able to smell the fragrance;
A: Number of evaluators able to smell the fragrance;
B: Number of evaluators unable to smell the fragrance.

When Y≥80%, it can be determined that the product has a fragrance retention effect. The test piece still had a fragrance retention effect after X hours (days) of air drying, indicating that the test piece “had X hours (days) fragrance retention effect”. When X≥48 hours, it indicates that the sample “possesses a long-lasting fragrance retention effect of X hours (days).”

TABLE 7

| | Percentage of evaluators able to smell fragrance | | | |
|---|---|---|---|---|
| Groups | 7 days/% | 30 days/% | 60 days/% | 90 days/% |
| Example 1 | 100 | 99 | 95 | 93 |
| Example 2 | 100 | 92 | 88 | 85 |
| Example 3 | 100 | 95 | 90 | 84 |
| Example 4 | 100 | 97 | 92 | 86 |
| Example 5 | 100 | 95 | 89 | 86 |
| Example 6 | 100 | 93 | 88 | 84 |
| Example 7 | 100 | 92 | 85 | 83 |
| Example 8 | 100 | 90 | 82 | 80 |
| Example 9 | 100 | 98 | 92 | 89 |
| Comparative Example 1 | 80 | 0 | 0 | 0 |
| Comparative Example 2 | 80 | 0 | 0 | 0 |
| Comparative Example 3 | 80 | 0 | 0 | 0 |
| Comparative Example 4 | 95 | 86 | 72 | 49 |
| Comparative Example 5 | 87 | 70 | 51 | 20 |
| Comparative Example 6 | 94 | 90 | 77 | 43 |
| Comparative Example 7 | 91 | 62 | 41 | 0 |

### 7. Moisture and Volatile Matters Content Test:

The test was conducted according to the method specified in Chapter 15 of GB/T 13173-2021 “Surface active agents-Test methods for detergents”. First, a weighing bottle was made with constant weight, then 2 g of the composition was accurately weighed into the weighing bottle, put into an oven at (105±2° C.) to dry for 4 h, then cooled and weighed, and the content of moisture and volatile matters in the sample were calculated.

The results were reported in Table 8.

TABLE 8

| | Moisture and volatile matters content/% |
|---|---|
| Groups | (Storing for one month at 25° C.) |
| Example 1 | 7.63 |
| Example 2 | 4.58 |
| Example 3 | 1.82 |
| Example 4 | 10.70 |
| Example 5 | 13.05 |
| Example 6 | 2.15 |
| Example 7 | 7.02 |
| Example 8 | 8.20 |
| Example 9 | 14.40 |
| Comparative Example 1 | 15.50 |
| Comparative Example 2 | 15.43 |
| Comparative Example 3 | 15.84 |
| Comparative Example 4 | 5.42 |
| Comparative Example 5 | 21 |
| Comparative Example 6 | 5.26 |
| Comparative Example 7 | 20 |
| Comparative Example 8 | 2.91 |

In Examples 1-9, Comparative Examples 4 and 6, since no additional water was added, the measured moisture and volatile content correspond to the amount of fragrance added. From Table 8, it can be seen that Examples 1-9 had low essence loss after one month of storage at 25° C. after preparation, and that the test pieces washed with the compositions in Examples 1-9 were considered to have up to 80% fragrance after 100 days, indicating long-lasting fragrance retention. Compared with Example 1, the moisture and volatile matters contents obtained from the tests of Comparative Examples 4 and 6 were lower than those of Example 1, indicating that the loss of essence occurred during the granulation process of Comparative Examples 4 and 6. Comparative Examples 1-3 used sucrose and sodium chloride crystals as carriers, moisture absorption made the content of the test result greater than the addition amount of the essence, the essence was physically adsorbed on the surface, and the essence was easily volatilized in daily storage so that the fragrance retention effect was not durable. In Comparative Examples 5 and 7, 40-50% water was added during the mixing process, resulting in a higher moisture content in the fragrance beads. This made them more prone to moisture absorption, not only reducing the longevity of the fragrance but also increasing the risk of mold formation. The addition of water made the body of the material more tightly bound, and in order to remove moisture, the temperature of Comparative Examples 5 and 7 should be set at 90-100° C. in the screw extrusion granulator, which increased the loss of essence and made it difficult to completely remove moisture, and the fragrance retention effect was not durable.

### 8. Mite-Removing Test

8 g of the composition was thoroughly dissolved in 4 L of 250 mg/kg CaCl₂) hard water to obtain a sample solution to be tested. A vertical decontamination tester was used to transfer the above sample solution to be tested into a decontamination tank and preheat at 30° C.±1° C. The JB-00 test piece containing mites was placed into the decontamination tank, stirred at 120 r/min for 20 min, and rinsed three times, and the number of mites remaining on the test piece was counted.

The calculation formula is shown below and the results are reported in Table 9.

$$Z = \frac{D - C}{D} \times 100 \%$$

Wherein:
Z: Mite-removing rate;
C: The number of mites on the test piece after washing;
D: The number of mites on the test piece before washing.

TABLE 9

| | | The number | |
|---|---|---|---|
| | The number | of mites | |
| | of mites | after | Mite-removing |
| Groups | input | washing | rate/% |
| Blank | 200 | 198 | 2 |
| Example 1 | 200 | 0 | 100 |
| Example 2 | 200 | 0 | 100 |
| Example 3 | 200 | 0 | 100 |
| Example 4 | 200 | 0 | 100 |
| Example 5 | 200 | 0 | 100 |
| Example 6 | 200 | 0 | 100 |
| Example 7 | 200 | 0 | 100 |
| Example 8 | 200 | 0 | 100 |
| Example 9 | 200 | 0 | 100 |
| Comparative Example 1 | 200 | 151 | 24.5 |
| Comparative Example 2 | 200 | 153 | 23.5 |
| Comparative Example 3 | 200 | 147 | 26.5 |
| Comparative Example 4 | 200 | 179 | 10.5 |
| Comparative Example 5 | 200 | 175 | 12.5 |
| Comparative Example 6 | 200 | 152 | 24 |
| Comparative Example 7 | 200 | 146 | 27 |

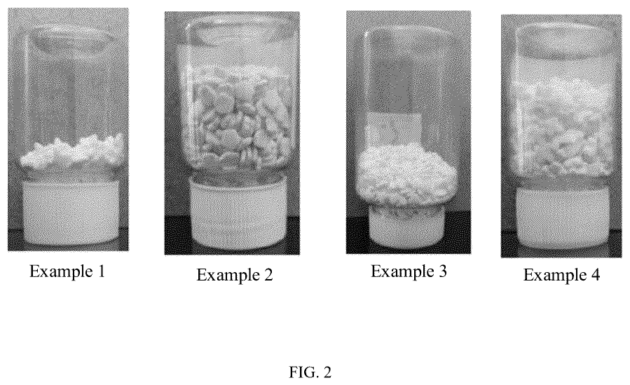

The state of the compositions of Example 1, Example 2, Example 3, and Example 4 after being stored at 60° C. for 20 months was shown in FIG. 2. Each composition showed no adhesion and no abnormality after storage at 60° C. for 20 months.

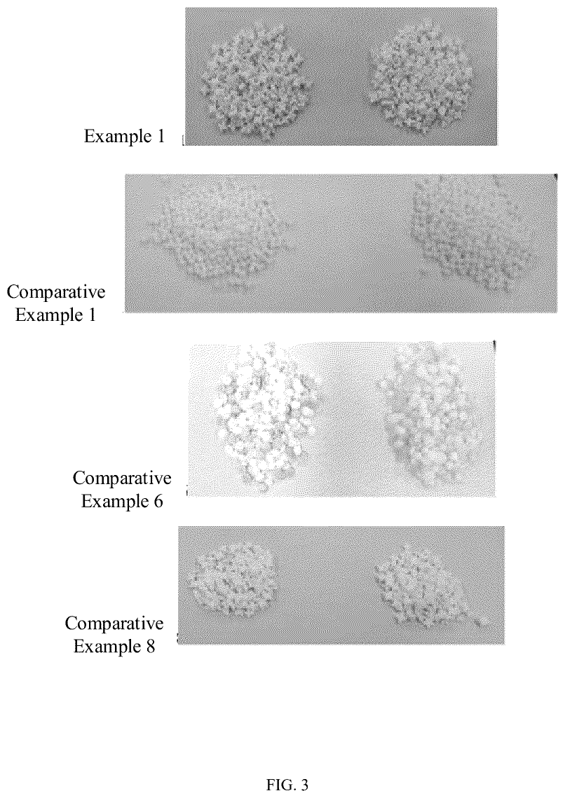

The state of the compositions of Example 1, Comparative Example 1, Comparative Example 6, and Comparative Example 8 after being stored at 25° C. and 60° C. for 1 month was shown in FIG. 3 As can be seen from FIG. 3, the compositions of Example 1 remained in good condition, but the compositions of Comparative Examples 1, 6, and 8 exhibited varying degrees of adhesion, and abnormalities, especially when tested at 60° C.

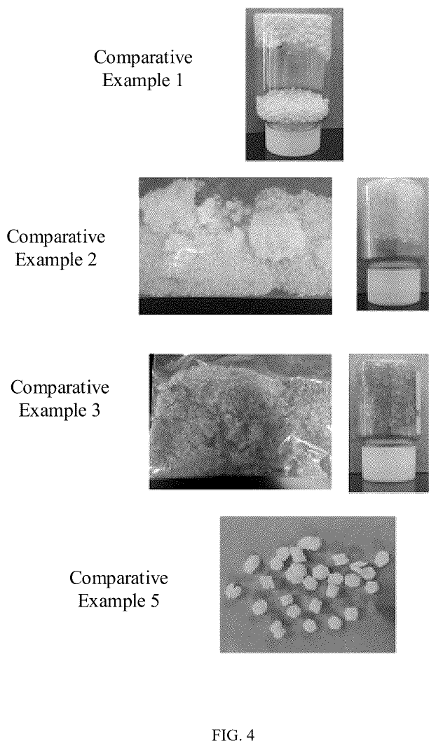

The state of the compositions of Comparative Examples 1-3 and Comparative Example 5 after being stored at 25° C. for 1 month was shown in FIG. 4. The composition of Comparative Example 1 exhibited adhesion, clustering, and wall adhesion, while the composition in Comparative Example 2 exhibited hardening and lumping, the composition in Comparative Example 3 also exhibited hardening and lumping, whereas the composition in Comparative Example 5 exhibited adhesion.

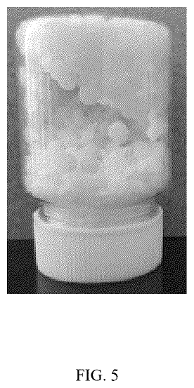

The state of the composition of Comparative Example 4 after being stored at 55° C. for 1 month was shown in FIG. 5. The composition of Comparative Example 4 exhibited adhesion.

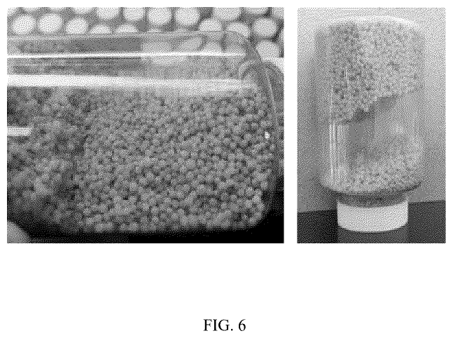

The state of the composition of Comparative Example 1 after being stored at 55° C. for 6 months was shown in FIG. 6. The composition of Comparative Example 1 exhibited adhesion, with components on the surface of the sucrose spheres exhibiting discoloration and moisture absorption.

This particular embodiment is merely an explanation of the present application and is not a limitation of the present application. A person skilled in the art, after reading the present specification, would have been able to make modifications to the present embodiment as required without inventive contribution, but only within the scope of the claims of the present application are protected by the patent laws.

What is claimed is:

1. A fabric fragrance-retaining and stain-removing composition containing an anionic surfactant, comprising the following raw materials by weight percentages: 5-29% binder, 10-35% the anionic surfactant, 5-60% filler, 1-6% water softener, 0.5-5% auxiliary agent, 0.01-2% antioxidant, 0.05-1% antibacterial and acaricide agent, and 1-15% essence;
wherein the binder comprises binder A, binder B, and binder C; in the raw materials of the fabric fragrance-retaining and stain-removing composition, a weight percentage of the binder A is 5-20%, a weight percentage of the binder B is 0.5-10%, and a weight percentage of the binder Cis 0.05-4%;
the binder A comprises at least one of sucrose, glucose, fructose, or lactose;
the binder B comprises at least one of polyethylene glycol or polypropylene glycol;
the binder C comprises at least one of sucrose fatty acid ester, polyethylene glycol glucoside fatty acid ester, polyethylene glycol 120 (PEG-120) methyl glucose triisostearate, or PEG-120 methyl glucose dioleate.

2. The fabric fragrance-retaining and stain-removing composition according to claim 1, wherein the anionic surfactant comprises at least one of sodium alkyl sulfate, sodium alpha-alkenyl sulfonate, sodium cocoyl methyl taurate, or sodium lauroyl glutamate.

3. The fabric fragrance-retaining and stain-removing composition according to claim 2, wherein the binder A is the sucrose, the binder B is a mixture of the polyethylene glycol and the polypropylene glycol, and the binder C is a mixture of the sucrose fatty acid ester, the polyethylene glycol glucoside fatty acid ester and the PEG-120 methyl glucose dioleate;
in the raw materials of the fabric fragrance-retaining and stain-removing composition, a weight percentage of the sucrose is 12-18%, a weight percentage of the polyethylene glycol is 1-9%, a weight percentage of the polypropylene glycol is 1-8%, a weight percentage of the sucrose fatty acid ester is 0.1-3%, a weight percentage of the polyethylene glycol glucoside fatty acid ester is 0.5-1.5%, and a weight percentage of PEG-120 methyl glucose dioleate is 0.1-3%.

4. The fabric fragrance-retaining and stain-removing composition according to claim 1, wherein a particle size of the binder A, the binder B, and the binder C is between 50 and 200 mesh.

5. The fabric fragrance-retaining and stain-removing composition according to claim 1, wherein the filler comprises at least two of maltodextrin, cyclodextrin, plant starch, porous starch, or cellulose.

6. The fabric fragrance-retaining and stain-removing composition according to claim 1, wherein the antibacterial and acaricide agent comprises at least one of dichlorobenzyl alcohol, cymene, zanthoxylum extract, or rice hull extract.

7. The fabric fragrance-retaining and stain-removing composition according to claim 1, wherein the auxiliary agent comprises at least one of glycerol, propylene glycol, butylene glycol, hexylene glycol, sorbitol, or isooctanol.

8. The fabric fragrance-retaining and stain-removing composition according to claim 1, wherein the water softener comprises at least one of sodium citrate, tetrasodium iminodisuccinate, tetrasodium glutamate diacetate, or trisodium methylglycine diacetate.

9. The fabric fragrance-retaining and stain-removing composition according to claim 1, wherein a length and a width of the fabric fragrance-retaining and stain-removing composition are 3 mm to 10 mm, a thickness of the fabric fragrance-retaining and stain-removing composition is 0.6 mm to 3 mm, and a density of the fabric fragrance-retaining and stain-removing composition is 0.6 to 1.2 g/mL.

10. A method for preparing the fabric fragrance-retaining and stain-removing composition containing the anionic surfactant according to claim 1, comprising the following steps: mixing and stirring the raw materials to form dry granulars, and then heating to melt, and extruding and pelletizing to obtain the fabric fragrance-retaining and stain-removing composition containing the anionic surfactant.
